(19) United States
(12) Patent Application Publication
(10) Pub. No.: US 2014/0237091 A1
(43) Pub. Date: Aug. 21, 2014

(54) Method and System of Network Discovery

(71) Applicants: Jason Allen Sabin, Lehi, UT (US); Paul Tiemann, Orem, UT (US)

(72) Inventors: Jason Allen Sabin, Lehi, UT (US); Paul Tiemann, Orem, UT (US)

(73) Assignee: DigiCert, Inc.

(21) Appl. No.: 13/769,141

(22) Filed: Feb. 15, 2013

(51) Int. Cl. H04L 12/26

(52) U.S. Cl. CPC H04L 43/00; H04L 63/00
USPC 709/223; 726/22

(57) ABSTRACT

The invention comprises a method of discovering certificate resources using internal and external sensor agents. This information is correlated to create an extensive network map and detect potential phishing threats. The information is stored in a repository of correlated information and returned to authenticated users.

### BACKGROUND

Companies worldwide rely on digital certificates to secure vital network and cloud-based resources. These digital certificates are issued by publicly trusted certification authorities to ensure they are properly configured and trusted in application software. Common certificate implementations include client certificates used to encrypt transactions and communications through email, SSL certificates used to encrypt communication over a SSL/TLS connection, and code signing certificates used to determine the authenticity of signed code. Organizations are continually discovering new uses for digital certificates.

Unfortunately, wide-spread adoption can create tracking and deployment nightmares for network administrators and policy administrators. This is a problem because an out-of-date or improperly configured certificate can lead to system vulnerabilities and create potential points of attack. Considering that global networks may have thousands of certificates from a wide variety of certificate providers, there is a need for a system that easily identifies certificate resources used in an organization. Because this type of information provides a complete map of the organization's network, any implementer would require a system for protecting the information from unauthorized use.

### SUMMARY OF THE INVENTION

The disclosed method and process uses a web crawler to discover certificate resources associated with a website. The crawler gathers information about the certificates and feeds the information back to a central repository. The information is then correlated with other information about the domain of the website to create a complete domain and certificate resource map and to identify possible phishing attacks.

The process also includes an internal discovery tool that a system administrator can use to locate certificate resources within a network or on a cloud service. The internal certificate resources are correlated with the crawler information to provide even more information on the organization's certificate resources. The information is provided to authenticated administrators to assist in policy decisions, detect potential attacks, and identify the use of certificate resources.

### BRIEF DESCRIPTION OF THE FIGURES

FIG. 1 is a flowchart showing one embodiment of the process.

FIG. 2 is a flowchart showing a separate embodiment of the process.

FIG. 3 is a diagram depicting the components of the external sensor agent embodiment.

FIG. 4 is diagram depicting how the phishing detection components interact.

FIG. 5 is a diagram depicting the components of the internal sensor agent embodiment.

FIG. 6 depicts an alternate embodiment of the phishing detection system.

FIG. 7 depicts an embodiment that combines the internal and external sensor agent.

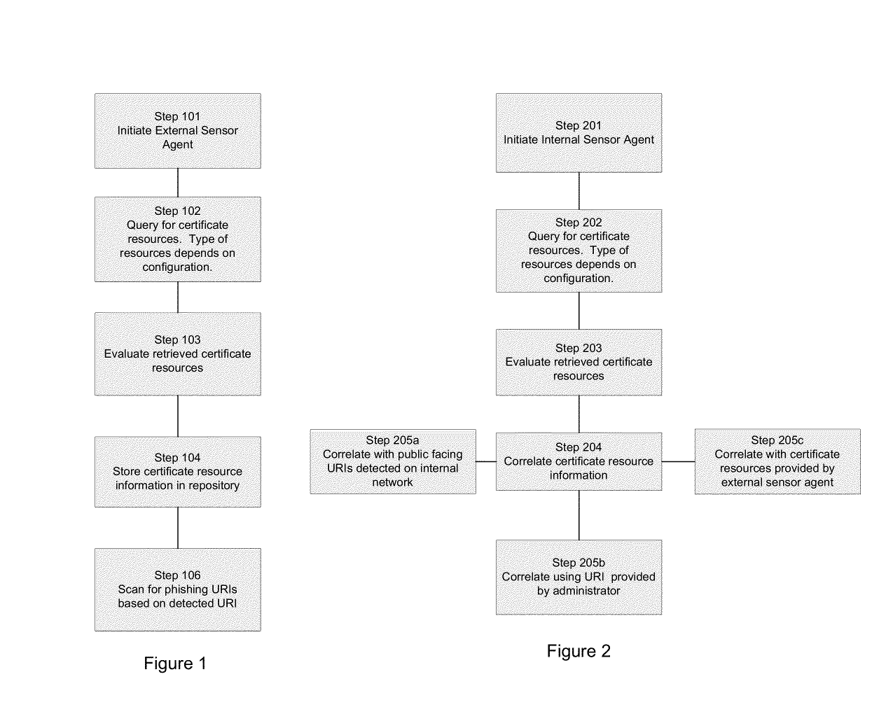

### DESCRIPTION OF INVENTION

The invention discloses a method and system for using certificate resources to map networks and detect potential phishing attacks. The invention ensures that this information is maintained confidentially by ensuring only authenticated users have access to the data.

The provided Figures illustrate various embodiments of the invention; however, the invention is not limited to the specific implementation shown in the Figures, as several of the steps and components are optional or intended only to increase performance, ease of use, and security of the overall system. A component, as used herein, may refer to a software package, virtual appliance, system, or other apparatus or process that can perform the described function.

In Step 102 and as shown in FIG. 2, an external sensor agent (a crawler) 100 searches the Internet 120 for certificate resources 120, which may include SSL Certificates, code signing certificates, client certificates, and other types of certificates. The external sensor agent gathers this information by searching for active URIs 110 and querying 310 the URI for a connection. For SSL certificates, if the query is successful, the server 140 hosting the URI will provide the certificate information as part of the SSL handshake 320. For code signing certificates, the external sensor agent can find code signing certificates by evaluating 330 whether software 170 located on the URI is signed and retrieving the signing certificate resource. For client certificates, the external sensor agent can gather emails 160 located on the server, analysing their signature, and evaluate any authentication mechanisms used by the server.

In Step 103, the external sensor agent transmits the certificate resources gathered to an evaluation engine 170 where the certificate resource details are evaluated. The evaluation engine extracts the appropriate certificate information and transmits the information to a repository 180 for storage. The information gathered depends on the needs of the service provider and its customers but may include the certificate resource, contents of the certificate resource, the location (and URI) of the certificate resource, the type of certificate resource, the timestamp, information about the external sensor agent, and information about any detected use of the certificate resource. Information obtained from a URI is associated with that URI in the repository so that the results of each URI are easily accessible.

The repository is a collection of databases that simply stores the information in a way that makes the information easily accessible. The repository may alternatively use a single database or may use multi-tenancy to separate the information into databases discovered networks. The information in the repository is also stored in a manner that associates the information with its source. This may be the organization named in the certificate resource, the URI where the certificate originated, or both. For example, an SSL certificate installed at DomainA with a subject of CompanyA can be associated with both DomainA and CompanyA, making the information to be available for entities querying about either subject. Another example is a code signing certificate used to secure software downloadable for DomainA, DomainB, and that names CompanyA as the publisher. The code signing certificate is stored in the repository as associated with all three subjects. Evaluating this information permits software owners to evaluate the spread of software (using code singing certificates) and easily detect copyright infringement issues and allow network administrators to track public leaks of sensitive information (using email certificates).

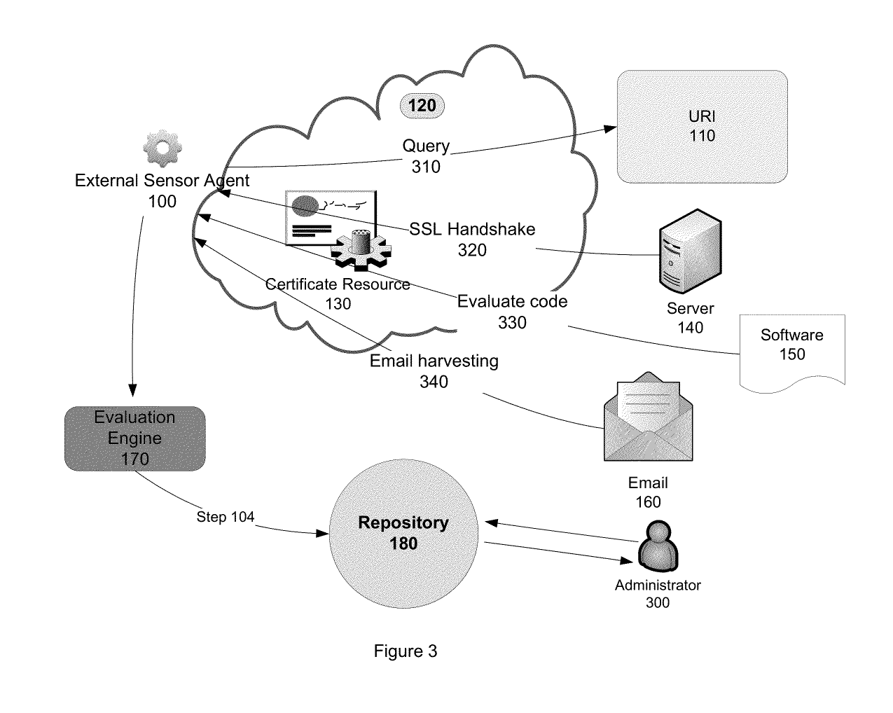

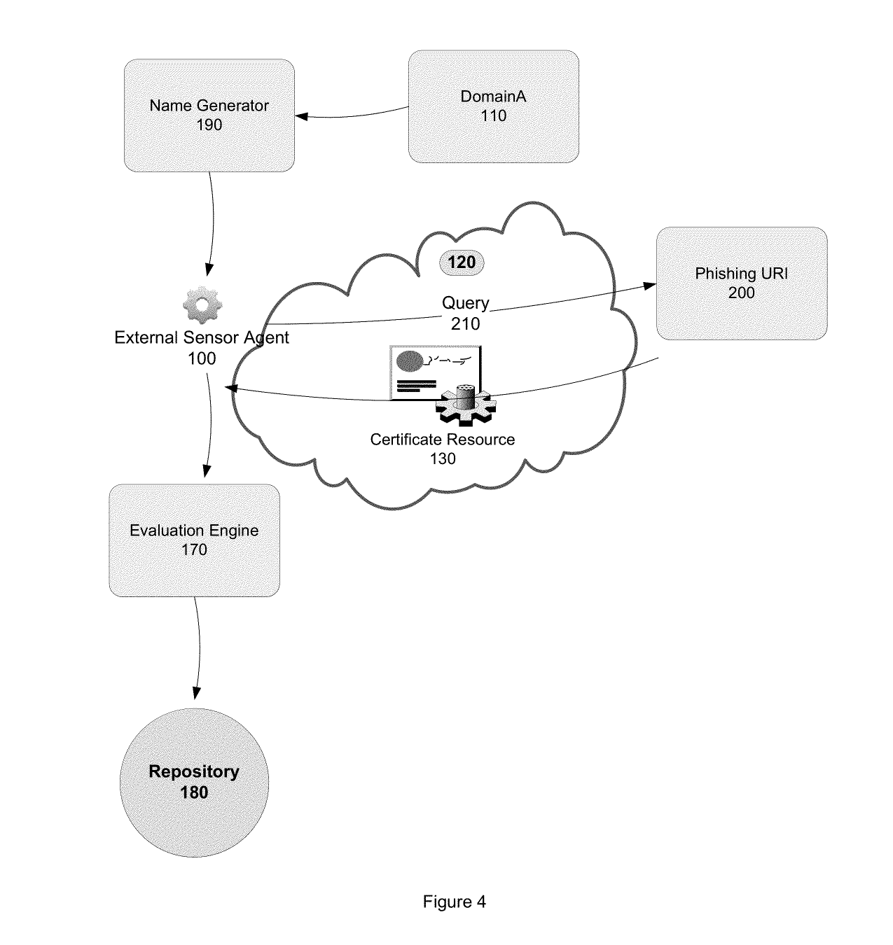

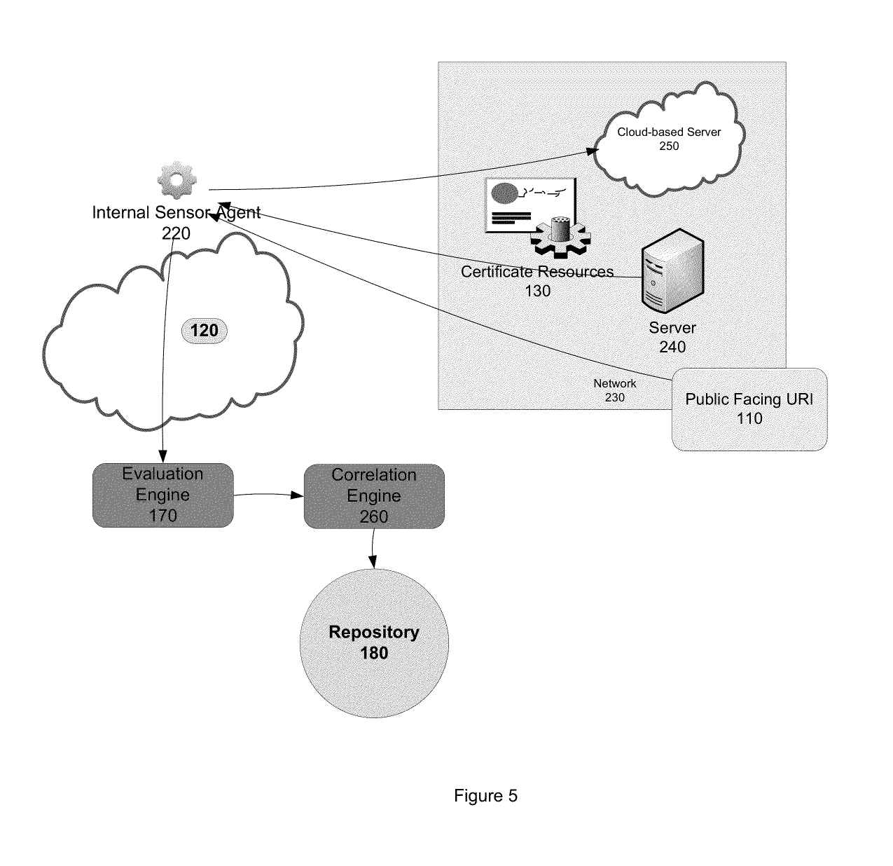

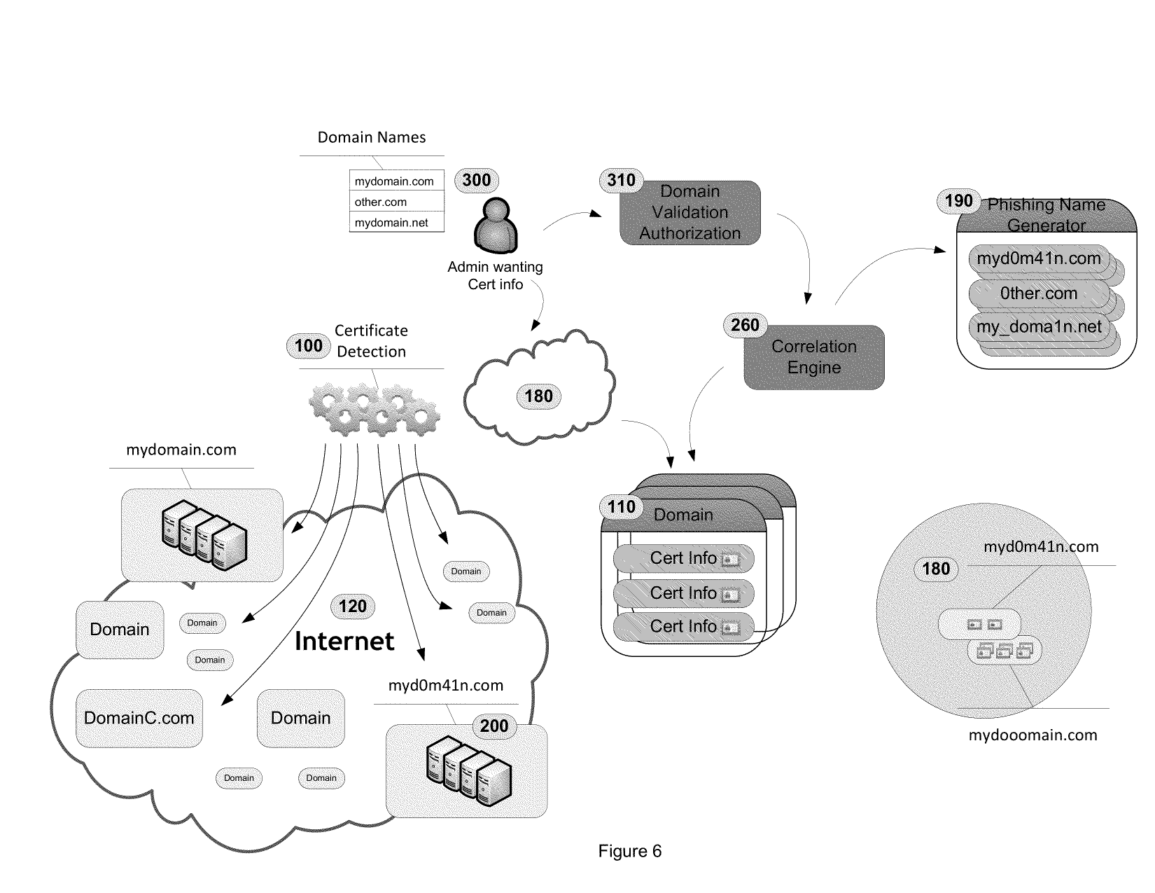

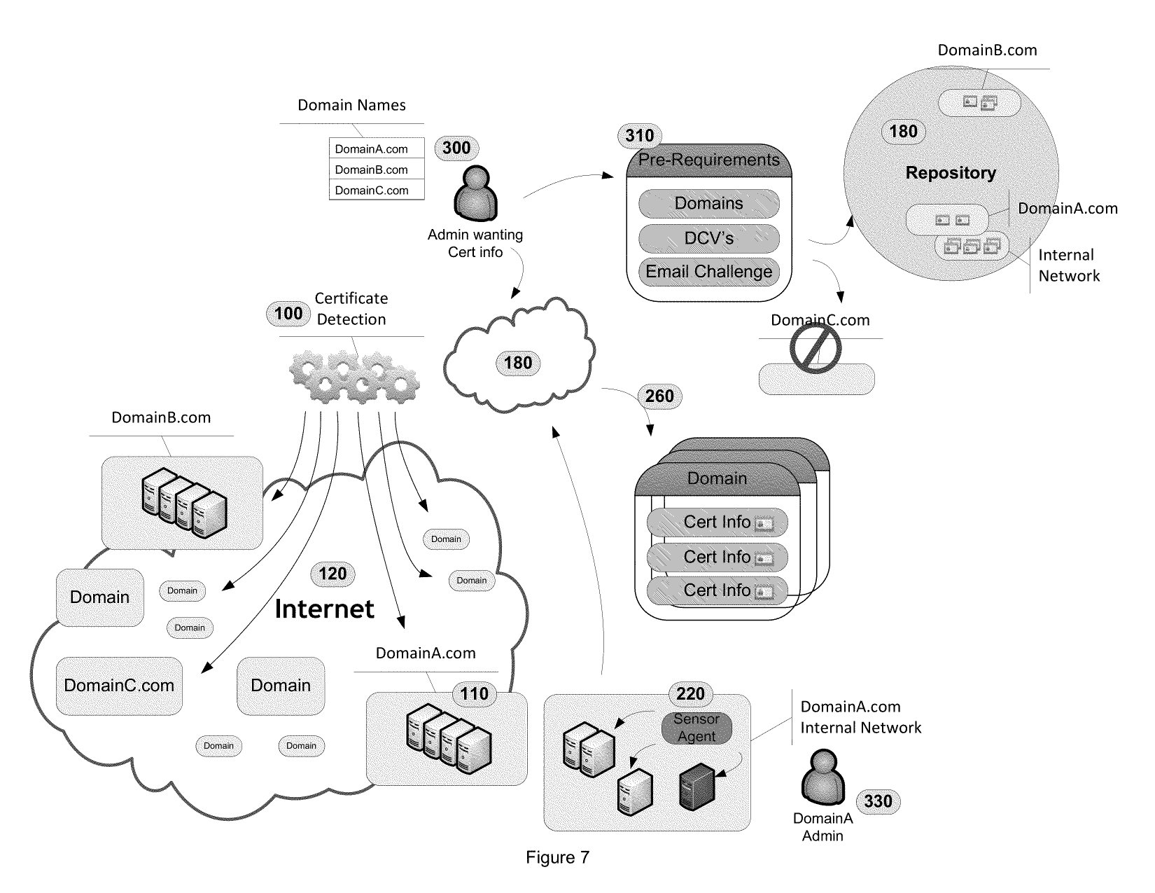

As shown in FIG. 3, the external sensor agent can also discover certificate resources used on URIs that contain confusingly similar names to the scanned URI. This information is useful for understanding potential phishing attacks and trademark infringement. The sensor agent detects these URIs using a name generator 190. A name generator either retrieves potential phishing names from a database or creates the phishing names using common misspellings of the domain and/or by substituting common special characters. For example, an external sensor tasked with finding derivations of DomainA may search for d0mainA, doma1nA, and dom4inA, and similar variations. A database may also specify that the sensor search for DMNA as a math to DomainA.

The certificate resources associated with detected phishing URIs are sent to the evaluation engine and stored in the repository as associated with the URI with which it may be confused.

The system may also include internal sensor agents 220 that scan for certificate resources 130 internal to a network 230, including network servers 240 and cloud-based servers 250. Information about detected certificates resources is gathered and stored in the repository. This information may include email certificates used by employees, certificates protecting internal resources, code signing certificates for released and unreleased software, SSL certificates on servers, etc. A network administrator may initiate multiple instances of the internal sensors to detect various certificate resource types or to scan multiple networks simultaneously. The administrator may customize the internal sensors to exclude specified certificate resources or restrict the information the internal sensors provide to the repository.

If a public-facing URI 110 is detected, the internal sensor agent can use a correlation engine 260 to associate the certificate resources of the internal network with the URI and any certificate resource information gathered by the external sensor agents. The correlation is made by associating each internal certificate resource in the repository with the public URI.

The correlation may also be made by scanning the repository information for detected internal certificate resource information. If a certificate resource in the repository matches a certificate resource found by an internal sensor agent, the relationship between the certificate resources is determined using the correlation engine. This may include associating the website using the certificate resource with the server hosting the resource or associating a mail server using a certificate resource to encrypt messages with detected email certificate resources.

Alternatively or in addition, an administrator may submit a URI to the correlation engine. The correlation engine then associates each internal certificate resources with the submitted URI.

For example, if an internal sensor agent detects a certificate resource for CompanyA on DomainA, the sensor agent queries the repository for a matching certificate resource, such as a certificate resource listing CompanyA as the subject or that was detected on DomainA by an external sensor agent. The certificate resources' serial numbers and issuer are identical. If a match is found, the repository is updated to reflect that the certificate resource was found in both locations, automatically associating the internal network components with the results of the external sensor agent scan.

The sensor agent can also access a crawler to perform a scan for potential phishing domains as described above. The crawler scans the internet for certificate resources that include potentially confusing names. The results of these scans are logged in the repository as associated with both the internal server name and the URI of the confusing name.

The correlation between internally and externally obtained information permits an administrator to easily access and review information for their entire network. For example, if an internal sensor agent discovers email certificate resources containing the “DomainB” root on a network, the repository stores each certificate resource under the DomainB subject. If the internal sensor agent later discovers that the same network contains a server hosting the DomainA site, the repository will record the affiliation between DomainA and DomainB. Both resources are considered part of the same network. An administrator requesting information on DomainB will receive notice of, and an opportunity to view, the relationship between DomainA and DomainB, including the shared certificate resources.

An administrator 300 may receive, either at the administrator's request or automatically upon discovery, information about one or more networks or URIs stored in the repository. The repository may require that any requested domains inter-relate or permit administrators to perform a broad search on unrelated information. An administrator may also retrieve all information provided by or about one or more organizations and can freely mix URIs and organization names. For example, an administrator may request retrieval of all information associated with “ABC Company”, DomainA.com, and DomainB.Com.

Before returning the information, the repository should authenticate the requester. This ensures that requester is related to the URI and prevents attackers from easily obtaining an organization's entire network diagram.

Authentication processes 310 may include requiring the administrator to present credentials (such as a recognized digital certificate), entering a password, using a WHOIS look-up to verify the administrator as associated with the domain, or using an email or domain challenge to one or more specified email addresses. Authorization for a domain is automatic if the request is made through a sensor agent used to scan an organization's network and that sensor agent determined its installation was on the same network as the requested domain.

The administrator's relationship to the URI and authentication is stored in the repository to provide auditable information about access to the repository and detect potential misuse of the information. After the administrator's relationship to the domain is authenticated, further access to information does not require authentication. Alternatively, the system can re-verify the administrator on a periodic basis (such as once every 1-3 years or on a weekly basis).

After authenticating the administrator, the repository returns a report on the certificate resources associated with the requested organizations and domains. This information provides (and may be displayed as) a complete map of the organization's network. The display should provide a high-level overview of the interactions between the network components, as detected by the certificate resources, and permit the user to delve into a more granular view of the information, such as permitting the user to view each certificate resource associated with the network.

If potential phishing domains are detected, by either an external or internal sensor agent, then repository will return this information as an alert to an administrator about potential phishing scams and domains they might want to secure.

What is claimed is:

1. A method to determine certificate resources associated with a network comprising:
a. Obtaining information from an external sensor agent,
b. Obtaining information from an internal sensor agent, and
c. Correlating the information from an internal sensor agent and the information from an external sensor agent.

2. A method according to claim 1, where the information obtained from the external sensor agent is about a certificate resource located on a URI associated with a network where the internal sensor agent gather information.

3. A method according to claim 1, further comprising sending the information obtained from the external sensor agent to an evaluation engine.

4. A method according to claim 1, further comprising storing information about the correlation in a repository.

5. A method according to claim 1, where the information obtained from an external sensor agent is provided to an administrator.

6. A method according to claim 5, where the administrator is authenticated as associated with a URI associated with information before the information is provided.

7. A method for detecting phishing domains comprising:
a. Receiving a domain name from a name generator,
b. Having an external sensor agent scan for the domain name, and
c. Sending the results of a scan to a repository.

8. A method according to claim 7, further comprising associating the results of scan with one or more domain names other than the domain name received from a name generator.

9. A method according claim 7, where the domain is created by substituting letters of a separate domain name.

10. A system for determining certificate resources associated with a network comprising:
a. An external sensor agent,
b. An internal sensor agent,
c. A repository where information obtained from the external sensor agent and internal sensor agent is deposited.

11. A system according to claim 10, further comprising a correlation engine that associates information provided by the external sensor agent with information provided by the internal sensor agent.

12. A system according claim 11, where the correlation engine associates information by matching information in certificate resources.

13. A system according to claim 10, where the external sensor agent is configured to gather certificate resources located on URIs.

14. A system for detecting phishing domains comprising:
a. A name generator,
b. An external sensor agent that searches for domain names provided by the name generator, and
c. A repository that stores information provided by the external sensor agent.

15. A system according to claim 14, further comprising a correlation engine that correlates information obtained by the external sensor agent with a second domain name.

16. A system according to claim 14, where the information provided by the external sensor agent is associated with information provided by an internal sensor agent.
